(19) United States
(12) Patent Application Publication
(10) Pub. No.: US 2011/0101217 A1
(43) Pub. Date: May 5, 2011

(54) Mass Spectrometric Method for Matrix-Free Laser Desorption/Ionization of Self-Assembled Monolayers

(75) Inventors: Sang Yun Han, Seoul (KR); Tae Geol Lee, Daejeon (KR); Dae Won Moon, Daejeon (KR)

(73) Assignee: KOREA RESEARCH INSTITUTE OF STANDARDS AND SCIENCE, Daejeon (KR)

(21) Appl. No.: 12/988,925

(22) PCT Filed: Apr. 24, 2009
(86) PCT No.: PCT/KR09/02145

§ 371 Date: Jan. 10, 2011

(30) Foreign Application Priority Data
Apr. 25, 2008 (KR) 10-2008-0038746

(51) Int. Cl. H01J 49/00

(52) U.S. Cl. 250/282

(57) ABSTRACT

Disclosed is a method for carrying out matrix-free mass spectrometry, which includes subjecting an analyte sample containing a self-assembled monolayer on the surface of a substrate to laser desorption/ionization. The method for carrying out matrix-free mass spectrometry involves simple pretreatment of an analyte sample with a cationic solution without using any solid matrix to cause effective laser desorption/ionization of the analyte sample, and minimizes a biochemical and physiological change in the sample that may occur during the pretreatment of the sample. In addition, the method is applicable to quantitative analysis because it provides high reproducibility of the results by virtue of the uniform treatment with the cationic solution over the whole areas of the sample. Further, the method enables two-dimensional mapping analysis.

### TECHNICAL FIELD

The present invention relates to a method for carrying out mass spectrometry of a self-assembled monolayer without using any matrix. More particularly, the present invention relates to a method for carrying out matrix-free mass spectrometry of a self-assembled monolayer by adding a cationic solution to cause laser desorption/ionization of the self-assembled monolayer.

### BACKGROUND ART

In general, biochips means bio-information detection devices including biomaterials, such as DNAs, proteins, antibodies, saccharide chains or cells, highly integrated on solid substrates, such as silicon, polymers, or the like. Such biochips are suitable for high-throughput analysis of a trace amount of sample, and are utilized to obtain biological information, such as gene expression behaviors, gene defects, protein distributions, etc., to diagnose diseases, to perform biochemical identification, and to increase a response rate or information processing rate. For example, protein chips are converted into microarrays by attaching proteins or ligands capable of reacting with specific proteins to solid surfaces, and then are used to analyze the presence or function of any biomolecules that bind specifically to the microarrays in a large scale at a high speed through analytical methods, including fluorometry, surface plasmon resonance (SPR) or mass spectrometry.

In this regard, mass spectrometry plays an important role in analyzing such biochips, particularly protein chips. Particularly, mass spectrometry is non-labeling detection technology that does not require attachment of a labeling substance generally needed in fluorometry. Unlike SPR for measuring interactions of biochemical substances with high sensitivity, mass spectrometry makes it possible to obtain direct information about the biochemical substances to be analyzed that undergo interaction or related biological reactions through information of molecular weights.

Among such mass spectrometric methods, matrix-assisted laser desorption/ionization (MALDI) has been widely used. MALDI is a method, in which beams, such as UV laser beams, are irradiated instantly to matrix crystals containing a mixture of high-molecular-weight materials, such as peptides and proteins, thereby allowing the high-molecular-weight biological analytes to be emitted in the form of gaseous ions, so that the molecular weights are measured or the structures are analyzed by a mass spectrometer. More particularly, MALDI involves diluting a non-volatile sample, such as a biochemical polymer, into and with matrix molecules as a UV absorbent to form crystals, and irradiating strong pulse type UV laser beams thereto to cause desorption/ionization from the crystals, wherein the structure of the sample is analyzed by determining the molecular weight of the sample molecule ions produced by the irradiation and emitted to vacuum or by using tandem mass spectrometry techniques. Mass spectrometry used mainly for such purposes include a time-of-flight mass spectrometry (TOF MS). The MALDI-TOF MS allows femtomole- or picomole-scaled analysis and enables ionization of biochemical substances, which, otherwise, would have difficulty in forming gaseous ions. However, the results of measurement using MALDI-TOF MS are significantly affected by the selection of a suitable matrix and optimization of crystallization conditions depending on the particular type of sample. In addition, since the matrix crystals are not formed uniformly, the results of measurement using MALDI-TOF MS may not have high reproducibility. For example, when the laser beams are irradiated to so-called hot spots, it is possible to obtain ion signals with strong intensity required for mass spectrometry. However, it is difficult to produce ions at other locations in the sample crystals. As a result, MALDI-TOF MS does not allow quantitative analysis and has difficulty in realizing mass imaging, such as chemical mapping.

Surface-enhanced laser desorption/ionization (SELDI)-TOF, which is based on MALDI-TOF MS, has been widely used in the field of protein chips. SELDI-TOF involves purifying a protein sample directly on a protein microarray that has been subjected to chromatographic surface treatment, treating the target protein detected on the array surface with a matrix, carrying out laser desorption/ionization, and carrying out mass spectrometry by using TOF MS. SELDI-TOF MS enables separation, detection and analysis of a bios ample directly on a protein chip with no need for any specific labeling. Additionally, SELDI-TOF MS has a detection range of 1-250 kDa and a detection limit of 1 femtomole, and allows high-speed analysis.

Other applications of MALDI mass spectrometry to protein chips, etc. include SAMDI (Self-Assembled Monolayers for MALDI) developed by Professor Mrksich (University of Chicago, USA) and coworkers. SAMDI is a method based on the self-assembled monolayer (SAM) technique, and detects the change in biochemical substances occurring on self-assembled monolayers and the biological substances, such as proteins, bound specifically thereto by using MALDI-TOF MS.

As described above, MALDI used in SAMDI-TOF, SELDI-TOF and MALDI-TOF requires formation of a matrix layer through the treatment with a matrix-containing solution in order to perform mass spectrometry of a polymeric biochemical substance, and thus entails a complicated process including selection of a particular type of matrix depending on the analyte to be detected and optimization of the composition and concentration of a solution to be applied and crystallization conditions. In addition, since the matrix solution applied on a monolayer forms non-uniform crystals after the evaporation of the solvent used therein, it is required to search for hot spots in order to obtain ion signals with intensity suitable for the analysis. Moreover, since ion signals with different intensities are obtained at different locations due to the non-uniformity of crystals, it is difficult to perform quantitative analysis and to obtain results with high reproducibility and reliability. Further, it is difficult to realize mass imaging such as chemical mapping.

Many matrix materials providing high ionization efficiency have acidic properties (pH 2.5-5). In many cases, organic solvents, such as alcohols or acetonitrile, are used in combination with such matrix materials to form matrix solutions. Such acidic conditions and the use of such organic solvents may affect the physiological or biochemical state of a biochemical substance and may interrupt weak interaction between biochemical substances. Therefore, the above-described MALDI methods are limited in their applications to biochips.

According to the present invention, it has been surprisingly found that treatment with a cationic solution alone without using any matrix may cause laser desorption/ionization of self-assembled monolayers as well as of analytes, such as organic polymers, peptides, carbohydrates, proteins, nucleic acids, etc., fixed thereto, and thus enables effective mass spectrometry.

### DISCLOSURE OF INVENTION

### Technical Problem

Provided is a method for carrying out mass spectrometry, which causes laser desorption/ionization of a self-assembled monolayer without using any matrix, and enables mass spectrometry of the self-assembled monolayer.

More particularly, the method enables mass spectrometry of a self-assembled monolayer containing an organic substance, inorganic substance, biochemical substance, or a combination thereof. The method disclosed herein includes pretreatment of a sample to cause laser desorption/ionization, prevents the biochemical or physiological effects of such pretreatment upon the sample, minimizes a difference in detection intensities at different locations of the analyte to provide a uniform detection result, allows quantitative analysis as well as qualitative analysis, enables two-dimensional chemical mapping, and provides results with high reproducibility.

### Technical Solution

In one aspect, there is provided a method for carrying out mass spectrometry, which includes adding a cationic solution containing cations to an analyte sample containing a self-assembled monolayer on the surface of a substrate, and carrying out mass spectrometry of the self-assembled monolayer by using laser desorption/ionization.

Particularly, the cations of the cationic solution added to the analyte sample form ion complexes with the self-assembled monolayer, and the molecules of the self-assembled monolayer are desorbed and emitted from the self-assembled monolayer by the laser beams. Then, thus formed gaseous cationic complexes of the laser-desorbed molecules of the self-assembled monolayer are subjected to mass spectrometry. Therefore, such simple treatment of adding the cationic solution to the analyte sample causes effective laser desorption/ionization without using any matrix, so that mass spectrometry of the self-assembled monolayer contained in the analyte sample may be carried out.

### Advantageous Effects

According to the method for carrying out mass spectrometry disclosed herein, laser desorption/ionization of an analyte sample is caused by adding an aqueous neutral cationic solution without using any matrix. Thus, the method involves simple pretreatment of samples, provides high reproducibility of the results, shows a low difference in the results between one location and another location in the analyte sample, enables two-dimensional mapping analysis, and minimizes a change in biochemical binding of the analyte that may occur during the pretreatment of the sample for mass spectrometry.

In addition, the method for carrying out mass spectrometry disclosed herein requires no matrix, so that the determination error may be significantly reduced. Further, the method provides high accuracy and sensitivity, thereby allowing detection of a trace amount of biochemical substance. Finally, since the method causes laser desorption/ionization of a self-assembled monolayer that reacts or binds specifically with the substance to be detected by adding an aqueous neutral cationic solution without using any matrix, it needs a shorter time to perform determination and pretreatment, is simple, and may be applied to various types of biochemical substances.

### BRIEF DESCRIPTION OF DRAWINGS

The above and other objects, features and advantages of the present invention will become apparent from the following description of preferred embodiments given in conjunction with the accompanying drawings, in which:

FIG. 1 shows the results of mass spectrometry of the self-assembled monolayer according to Example 1, wherein FIG. 1(a) illustrates the results of mass spectrometry of a test sample to which Na⁺ cations are added and FIG. 1(b) illustrates the results of mass spectrometry of a test sample to which K⁺ cations are added.

FIG. 2 shows the results of mass spectrometry of the self-assembled monolayer according to Example 2, wherein FIG. 2(a) illustrates the results of mass spectrometry after adding aqueous Na⁺ cationic solution (1) prepared from NaI salt, FIG. 2(b) illustrates the results of mass spectrometry after adding aqueous Na⁺ cationic solution (2) prepared from NaCl salt, FIG. 2(c) illustrates the results of mass spectrometry after adding aqueous K⁺ cationic solution (3) prepared from KI salt, and FIG. 2(d) illustrates the results of mass spectrometry after adding aqueous K⁺ cationic solution (4) prepared from KCl salt.

FIG. 3 shows the results of mass spectrometry of the self-assembled monolayers (SAMs) according to Example 3, wherein FIG. 3(a) illustrates the results of mass spectrometry of SAM (a), FIG. 3(b) illustrates the results of mass spectrometry of SAM (b), FIG. 3(c) illustrates the results of mass spectrometry of mixed SAM (c), and FIG. 3(d) illustrates the results of mass spectrometry of mixed SAM (d).

FIG. 4 shows the results of mass spectrometry of the self-assembled monolayer according to Example 4, wherein FIG. 4(a) illustrates the overall detection results measured at different locations, and FIG. 4(b) illustrates the individual detection intensities at each location.

FIG. 5 shows the results of mass spectrometry of the self-assembled monolayer according to Example 5, which demonstrate the effect of cation concentrations upon the detection intensities.

FIG. 6 shows transmission electron microscopy (TEM) images of gold nanoparticles having the self-assembled monolayers according to Example 6 attached thereto, and the results of mass spectrometry of the self-assembled monolayers attached to the gold nanoparticles, wherein FIG. 6(a) is a TEM image of Au(NP)—S—(CH₂)₁₁-(EG)₃—OH, FIG. 6(b) is a TEM image of Au(NP)—S—(CH₂)₁₁-(EG)₃—OCH₂—COOH, FIG. 6(c) illustrates the results of mass spectrometry of the self-assembled monolayer as shown in FIG. 6(a), and FIG. 6(d) illustrates the results of mass spectrometry of the self-assembled monolayer as shown in FIG. 6(b).

### BEST MODE FOR CARRYING OUT THE INVENTION

Hereinafter, the embodiments of the present invention will be described in detail with reference to accompanying drawings.

In the method disclosed herein, the cationic solution may be a solution containing alkali metal cations, alkaline earth metal cations, organic cations or mixed cations thereof. To prevent any changes in the biochemical state of an analyte sample caused by the presence of the cationic solution, the cationic solution may be adjusted to have adequate acidity, particularly to have a neutral pH.

The cations contained in the cationic solution may include those formed by dissolving alkali metal salts, alkaline earth metal salts, organic salts or mixed salts thereof into a solvent. Particularly, the alkali metal salts or the alkaline earth metal salts include organic metal salts and inorganic metal salts.

More particularly, the metal cations (alkali metal cations and alkaline earth metal cations) include those formed by dissolving alkali metal salts, alkaline earth metal salts or mixed salts thereof into a solvent. The alkali metal salts or alkaline earth metal salts may be organic metal salts or inorganic metal salts.

In one embodiment, the alkali metal salt or the alkaline earth metal salt may be a salt whose anion is selected from the group consisting of iodide, fluoride, chloride, bromide, hydroxide, phosphate, nitrate, acetate, citrate, tartarate, sulfate, carbonate or oxychloride ions. Particularly, the salt may be a fluoride salt, chloride salt, bromide salt or iodide salt.

The organic cations contained in the cationic solution may be at least one cation selected from the group consisting of oxonium, ammonium, quaternary ammonium, amidinium, guanidinium, pyridinium, morpholinium, pyrrolidonium, imidazolium, imidazolinium, triazolium, sulfonium, phosphonium, iodonium and carbonium ions.

To accomplish effective laser desorption/ionization of the self-assembled monolayer, the cationic solution may be a solution in which a metal (alkali metal or alkaline earth metal) salt whose anion is selected from iodide, fluoride, chloride, bromide, hydroxide, phosphate, nitrate, acetate, citrate, tartarate, sulfate, carbonate or oxychloride is dissolved. More particularly, the cationic solution may be a solution of sodium iodide, potassium iodide, lithium iodide, rubidium iodide, cesium iodide, beryllium iodide, magnesium iodide, calcium iodide, strontium iodide, barium iodide, sodium chloride, potassium chloride, lithium chloride, rubidium chloride, cesium chloride, beryllium chloride, magnesium chloride, calcium chloride, strontium chloride, barium chloride, sodium bromide, potassium bromide, lithium bromide, rubidium bromide, cesium bromide, beryllium bromide, magnesium bromide, calcium bromide, strontium bromide, barium bromide, sodium fluoride, potassium fluoride, lithium fluoride, rubidium fluoride, cesium fluoride, beryllium fluoride, magnesium fluoride, calcium fluoride, strontium fluoride, barium fluoride or a mixture thereof.

Solvents that may be used in preparing the cationic solution include any solvents capable of dissolving at least one compound selected from the group consisting of the alkali metal salts, alkaline earth metal salts, oxonium salts, ammonium salts, quaternary ammonium salts, amidinium salts, guanidinium salts, pyridinium salts, morpholinium salts, pyrrolidonium salts, imidazolium salts, imidazolinium salts, triazolium salts, sulfonium salts, phosphonium salts, iodonium salts and carbonium salts. However, water may be a solvent suitable for minimizing effects of the addition of the cationic solution upon the analyte sample.

The cationic solution may contain the cations in a molar concentration of 0.0001 mM to 1 M, particularly of 0.001 mM to 400 mM. When the molar concentration of the cations is less than 0.0001 mM, laser desorption/ionization of the self-assembled monolayer may not be carried out sufficiently by the cations upon the irradiation of laser beams. On the other hand, when the molar concentration of the cations is higher than 1 M, it is not possible to obtain high reproducibility due to the precipitation of the salt on the surface of the self-assembled monolayer.

The addition of the cationic solution to the analyte sample may be performed by dipping the analyte into the cationic solution, by applying (e.g. spraying) the cationic solution to the analyte, or by dropping liquid droplets of the cationic solution to the analyte.

In another embodiment, the sample, to which the cationic solution is added, may be optionally dried depending on the particular type of the mass spectrometer, before carrying out mass spectrometry. For example, when using a vacuum chamber, no separate drying operation is required, because the analyte sample may be dried while it is placed in the chamber and the chamber is brought into a general vacuum state. However, when using a chamber under room-temperature ambient-pressure conditions, the liquid phase in the analyte sample may be separately evaporated and dried. Such drying operation may be performed by removing the liquid phase (solvent) via evaporation at room temperature. However, even when using a chamber under room-temperature ambient-pressure conditions, any additional drying operation may not be performed and the analyte may be directly subjected to mass spectrometry in its wet condition. Herein, as laser beam sources, pulse type IR lasers may be used (wavelength range: 2.5-3.5 μm or 700-900 nm).

After adding the cationic solution to the analyte sample, mass spectrometry is carried out by using a general process and system for mass spectrometry. This forms another feature of the method disclosed herein. In other words, the method allows the use of an existing mass spectrometer for MALDI without any modification to carry out mass spectrometry of the self-assembled monolayer effectively. Particularly, the method for carrying out mass spectrometry disclosed herein may be performed by using existing mass spectrometers for MALDI, including time-of-flight mass spectrometer (TOF-MS), matrix-assisted laser desorption/ionization Fourier transformation-mass spectrometer (MALDI FT-MS), matrix-assisted laser desorption/ionization quadrupole-time-of-flight (MALDI q-TOF) and atmospheric pressure matrix-assisted laser desorption/ionization (AP-MALDI) systems. In addition, the mass spectrometer systems for MALDI include those systems for carrying out mass spectrometry under vacuum or under low pressure (atmospheric pressure).

The substrate for forming the self-assembled monolayer may include a metal, metal oxide, semiconductor, semiconductor oxide, non-conductor or amorphous material capable of forming a self-assembled monolayer. The substrate may be a multi-layer type (including core-shell type) or monolayer type substrate, and may have a plate-like, patterned, nanowire-like or nanoparticle-like shape.

Particularly, the substrate may be any material capable of forming a monolayer through spontaneous binding with surface atoms forming the substrate. Particularly, the substrate may be a metal, such as Au, Ag, Pd, Pt, Cu, Zn, Fe or In, oxide thereof, Si, Fe₂O₃, SiO₂ or ITO (indium tin oxide) glass, and more particularly Au.

To produce ion complexes of the cations with the self-assembled monolayer more effectively via the irradiation of laser beams, the self-assembled monolayer may include an oxygen-containing moiety. The oxygen-containing moiety may be selected from the group consisting of ethylene glycol (—O—CH₂—CH₂—), carboxylic acid (—COOH), alcohol (—OH), ether (—O—), ester (—COO—), ketone (—CO—), aldehyde (—COH), amide (—NH—CO—) and aromatic derivatives thereof (e.g. phenol, —C₆H₅—OH).

In one embodiment, the self-assembled monolayer may include a functional group to which an organic polymer, organometal compound, peptide, carbohydrate, protein, lipid, metabolite, antigen, antibody, enzyme, amino acid, aptamer, saccharide or nucleic acid is attached. Particularly, the organometal compound, peptide, carbohydrate, protein, lipid, metabolite, antigen, antibody, enzyme, amino acid, aptamer, saccharide or nucleic acid fixed to the functional group may be in a condition before or after it is subjected to a specific reaction with a chemical or biochemical substance.

In another embodiment, the self-assembled monolayer may include a functional group capable of reacting or binding specifically with a chemical or biochemical substance, a sulfur reactive group, an alkane chain group and an ethylene glycol moiety. As mentioned above, the functional group may be one subjected to a specific reaction with a chemical or biochemical substance, or one bound specifically to the chemical or biochemical substance.

In still another embodiment, the functional group of the self-assembled monolayer may include at least one selected from alkane groups, alcohol groups, carboxylic acid groups, amine groups and maleimide groups.

In still another embodiment, the self-assembled monolayer may include a functional group that reacts or binds specifically with a chemical or biochemical substance to be detected and a sulfur reactive group, and may be self-assembled on a gold surface (gold plate) via sulfur.

In yet another embodiment, the self-assembled monolayer may include a functional group that reacts or binds specifically with a chemical or biochemical substance to be detected, a sulfur reactive group, an alkane chain group and an ethylene glycol moiety. More particularly, the ethylene glycol moiety may be an oligo(ethylene glycol) moiety.

As described above, the matrix-free method for carrying out mass spectrometry disclosed herein enables mass spectrometry of a self-assembled monolayer itself, allows analysis of the presence and behavior of a reaction with an organic polymer, organometal compound, peptide, carbohydrate, protein, lipid, metabolite, antigen, antibody, enzyme, amino acid, aptamer, saccharide or nucleic acid fixed to the functional group of the self-assembled monolayer and an external chemical/biological substance, and enables analysis of an external chemical/biochemical substance specifically bound to the functional group of the self-assembled monolayer.

Herein, detection of the analyte sample via mass spectrometry includes information about locations (i.e., information about locations where laser beams are irradiated to the analyte sample) and the detection intensity of the analyte at a specific location. Thus, it is possible to obtain two-dimensional areal information of the analyte sample to be detected. The detection intensities of the analyte at different locations may be transformed into two-dimensional images. Particularly, in such images, color, saturation, brightness or a combination thereof may be adjusted depending on detection intensities at different locations.

### MODE FOR THE INVENTION

The examples and experiments will now be described. The following examples and experiments are for illustrative purposes only and not intended to limit the scope of the present invention.

As described above, the method disclosed herein enables mass spectrometry of a self-assembled monolayer (SAM) through the treatment with a neural cationic solution without using any matrix. Formation of the self-assembled monolayer and attachment thereof to a substrate may be performed according to processes known to those skilled in the art (e.g. Jing Li et. al, Langmuir (2007), vol. 23, pp. 11826-11835 and Benjamin et. al, Langmuir (2003), vol. 19, pp. 1522-1531). In the following examples, detailed description of the process for preparing a self-assembled monolayer will be omitted, and several embodiments of attachment of a SAM to a substrate will be described in brief.

Examples 1 to 5 use a SAM bound to an Au plate, while Example 6 uses a SAM bound to Au nanoparticles.

The Au plate used in Examples 1 to 5 includes an Au plate stacked on the top of a silicon wafer. The gold-plated silicon wafer was cleaned with a superpiranha solution (H₂O₂:H₂NO₃:H₂SO₄ in a 10:1:6 ratio), which was found to give a higher reproducibility than a piranha treatment. The wafer was thoroughly rinsed with deionized water and ethanol, and then cut into ˜1×1 cm² pieces. A SAM was prepared by dipping the chip into a 1 mM ethanol solution of thiol or disulfide reagent, typically for 12 h. The reagents for SAMs were commercially available and used without further purification (>95%, CosBiotech, Daejeon, Korea).

To attach the SAM to the Au plate, Au—S bonding was used. For example, a SAM with an OH terminal (Au—S—(CH₂)₁₁-(EG)₆—OH) was prepared by using the thiol reagent of HS—(CH₂)₁₁-(EG)₆—OH. The notation EG stands for ethylene glycol (—OCH₂CH₂—) moiety. A methoxy-terminated SAM (Au—S—(CH₂)₁₁-(EG)₃—OCH₃) was prepared using HS— (CH₂)₁₁-(EG)₃—OCH₃.

In the case of different types of SAMs attached to the same substrate in the following examples, such SAMs are designated as mixed SAMs. For example, a mixed SAM with acetylene and ethylene terminals was prepared by using the disulfide reagent of H₂Cd=CH—CH₂O-(EG)₃— (CH₂)₁₁—S—S—(CH₂)₁₁-(EG)₃-OCH₂-Ct≡CH. To prepare a mixed SAM with NH₂ and OH terminals, a 1:1 solution of HS—(CH₂)₁₁-(EG)₆—NH₂ and HS—(CH₂)₁₁-(EG)₃—OH in ethanol was used (total concentration: 2 mM). Then, the SAMs were rinsed and dried under nitrogen stream.

### Example 1

### Mass Spectrometry of SAM Via Pretreatment with Cationic Solution

NaI (Sigma-Aldrich, >99.99%) was dissolved into double distilled water to obtain a 10 mM aqueous Na⁺ cationic solution. In a separate container, KI (Sigma-Aldrich, >99.99%) was dissolved into double distilled water to obtain a 10 mM aqueous K⁺ cationic solution. All the cationic solutions thus prepared had a neutral pH.

As the test sample to be analyzed, a self-assembled monolayer of Au—S—(CH₂)₁₁-(EG)₆—OH bound to Au (plate) and having an alcohol group, a sulfur reactive group, an alkane chain group and an ethylene moiety was used. The test sample was dipped into each of the aqueous Na⁺ cationic solution and the aqueous K⁺ cationic solution for 10 minutes, separated and recovered therefrom, and dried at room temperature for 10 minutes.

The test samples, to which Na⁺ cations and K⁺ cations were added, were subjected to mass spectrometry by using a MALDI-TOF mass spectrometer (Autoflex III available from Bruker-Daltonics, Germany) equipped with 355 nm UV laser, in the absence of a matrix. The laser beams irradiated to the test samples were pulses with several nanosecond pulsewidth, each pulse having an energy of 50-200 μJ. The mass spectrum was obtained by using 30-50 laser shots. If necessary, the mass spectrum was obtained by up to about 200 shots, followed by averaging.

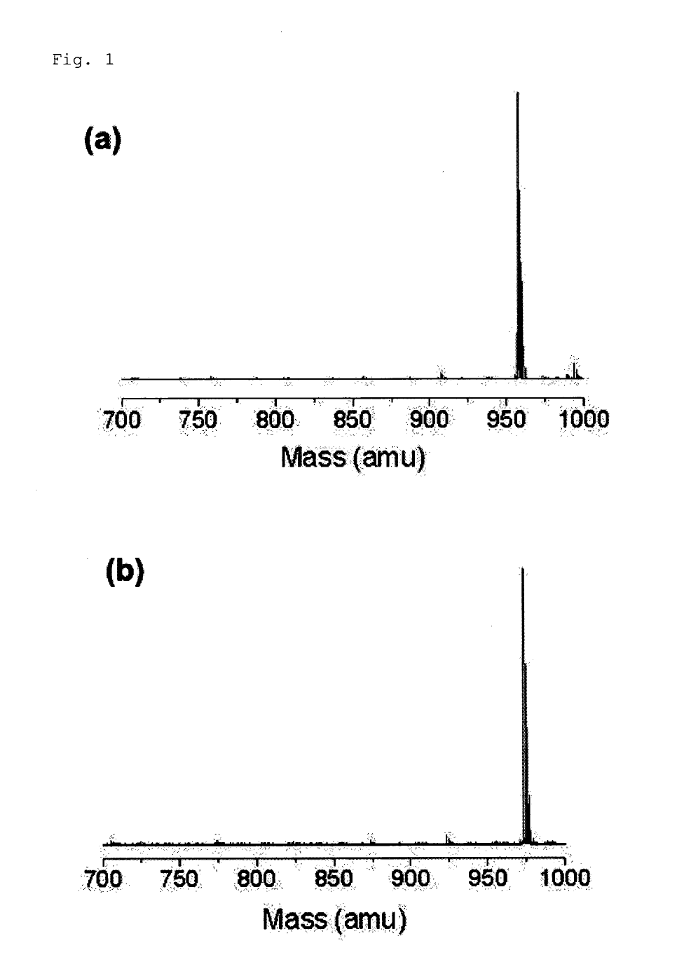

FIG. 1(a) illustrates the results of mass spectrometry of a test sample to which Na⁺ cations are added and FIG. 1(b) illustrates the results of mass spectrometry of a test sample to which K⁺ cations are added. As can be seen from FIG. 1, the monolayer is laser desorbed/ionized in the form of a specific disulfide type ion complex, i.e., (HO-(EG)₆—(CH₂)₁₁—S—S—(CH₂)₁₁-(EG)₆—OH)Na⁺ (mass: 957.6 amu) as shown in FIG. 1(a), or (HO-(EG)₆—(CH₂)₁₁—S—S—(CH₂)₁₁-(EG)₆-OH)K⁺ (mass: 973.6 amu) as shown in FIG. 1(b), by treating it with an aqueous solution containing cations. This demonstrates that the mass spectrometry was carried out effectively for the self-assembled monolayer.

### Example 2

### Mass Spectrometry of SAM Depending on Particular Type of Cationic Solution

NaI (Sigma-Aldrich, >99.99%) was dissolved into double distilled water to obtain a 10 mM aqueous Na⁺ cationic solution (1). In another container, NaCl (Sigma-Aldrich, >99.99%) was dissolved into double distilled water to obtain a 10 mM aqueous Na⁺ cationic solution (2). In a separate container, KI (Sigma-Aldrich, >99.99%) was dissolved into double distilled water to obtain a 10 mM aqueous K⁺ cationic solution (3). Further, KCl (Sigma-Aldrich, >99.99%) was dissolved into double distilled water to obtain a 10 mM aqueous K⁺ cationic solution (4). All the cationic solutions thus prepared had a neutral pH.

In a similar manner to Example 1, a self-assembled monolayer of Au—S—(CH₂)₁₁-(EG)₆—OH bound to Au (plate) was used as the test sample to be analyzed. The specimen was dipped into each of the aqueous Na⁺ cationic solutions (1) and (2), as well as the aqueous K⁺ cationic solutions (3) and (4) for 10 minutes, and then dried in air at room temperature for 10 minutes.

The test samples, to which Na⁺ cations and K⁺ cations were added, were subjected to mass spectrometry by using a MALDI-TOF mass spectrometer (Autoflex III available from Bruker-Daltonics, Germany) equipped with 355 nm UV laser, in the absence of a matrix. The laser beams irradiated to the test samples were pulses with several nanosecond pulse width, each pulse having an energy of 50-200 μJ. The mass spectrum was obtained by using 30-50 laser shots. If necessary, the mass spectrum was obtained by up to about 200 shots, followed by averaging.

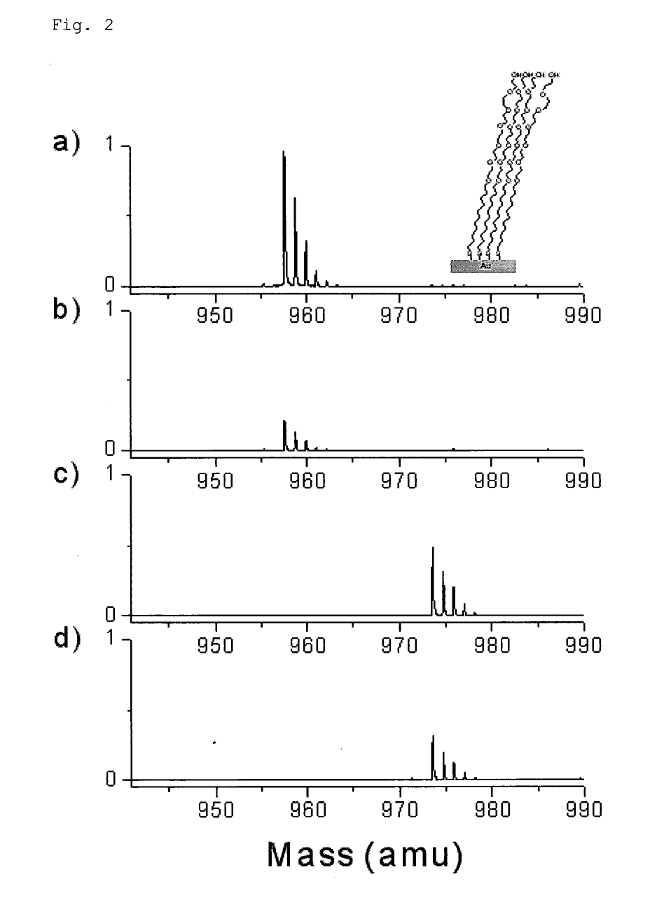

FIG. 2(a) illustrates the results of mass spectrometry after adding the aqueous Na⁺ cationic solution (1), FIG. 2(b) illustrates the results of mass spectrometry after adding the aqueous Na⁺ cationic solution (2), FIG. 2(c) illustrates the results of mass spectrometry after adding the aqueous K⁺ cationic solution (3), and FIG. 2(d) illustrates the results of mass spectrometry after adding the aqueous K⁺ cationic solution (4).

As can be seen from the results, regardless of the particular type of the salt used for preparing each aqueous cationic solution, the monolayer is laser desorbed/ionized in the form of a disulfide type ion complex, i.e., (HO-(EG)₆—(CH₂)₁₁—S—S—(CH₂)₁₁-(EG)₆—OH)Na⁺ (mass: 957.6 amu and the isotope pattern thereof), when adding the aqueous Na⁺ cationic solution (1) or (2), and in the form of a difulfide type ion complex, i.e., (HO-(EG)₆—(CH₂)₁₁—S—S—(CH₂)₁₁-(EG)₆-OH)K⁺ (mass: 973.6 amu and the isotope pattern thereof), when adding aqueous K⁺ cationic solution (3) or (4).

The results as shown in FIG. 2(a) to FIG. 2(d), which demonstrate that the self-assembled monolayer is laser desorbed/ionized effectively into its specific disulfide type ion complex, regardless of the particular type of the salt used for preparing each cationic solution. Particularly, the ionization efficiency is the highest when NaI was used.

### Example 3

### Mass Spectrometry Using Different Types of SAM Via Treatment with Cationic Solution

The pretreatment and mass spectrometry disclosed herein were carried out by using different types of self-assembled monolayers attached to a gold plate as shown in the following Table 1.

TABLE 1

| Sample | Self-Assembled Monolayer (SAM) |
|---|---|
| SAM(a) | Au—S—(CH₂)₁₁-(EG)₆-OH |
| SAM(b) | Au—S—(CH₂)₁₁-(EG)₃-OCH₃ |
| mixed SAM(c) | Au—S—(CH₂)₁₁-(EG)₃-CH═CH₂ |
| | and |
| | Au—S—(CH₂)₁₁-(EG)₃-C═CH |
| mixed SAM(d) | Au—S—(CH₂)₁₁-(EG)₃-OH |
| | and |
| | Au—S—(CH₂)₁₁-(EG)₅-NH₂ |

NaI (Sigma-Aldrich, >99.99%) was dissolved into double distilled water to obtain a 10 mM aqueous Na⁺ cationic solution. The Na⁺ cationic solution thus prepared had a neutral pH.

Next, each of the samples of SAM(a), SAM(b), mixed SAM(c) and mixed SAM(d) was dipped into the Na⁺ cationic solution, and dried in air at room temperature for 10 minutes. Then, mass spectrometry was carried out by using the same conditions and system as described in Example 2.

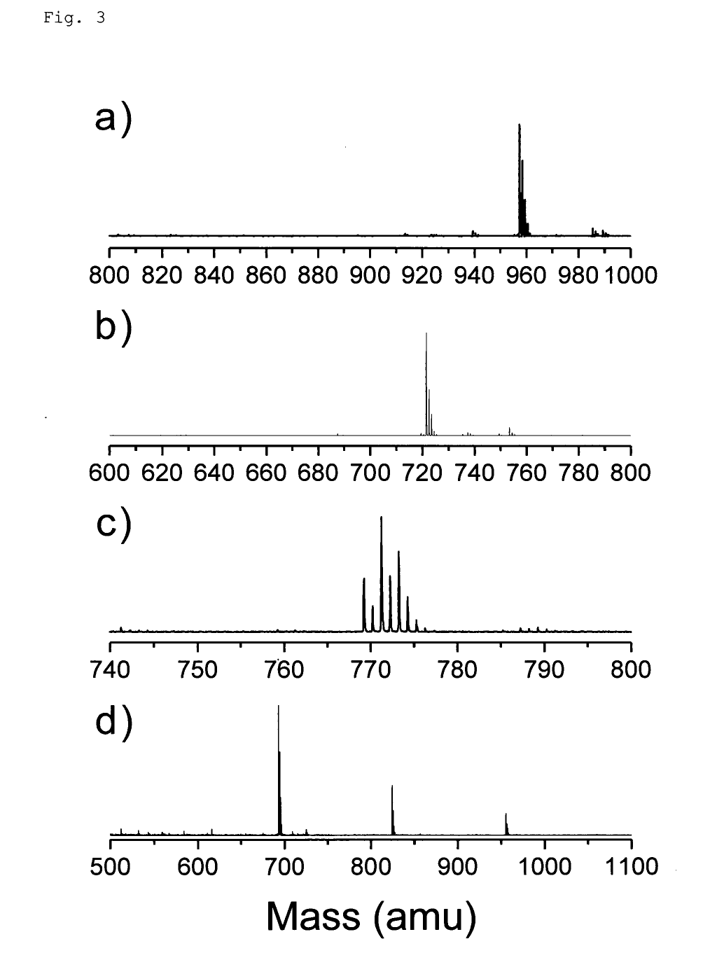

FIG. 3(a) shows the results of mass spectrometry of SAM(a), FIG. 3(b) shows the results of mass spectrometry of SAM(b), FIG. 3(c) shows the results of mass spectrometry of mixed SAM(c), and FIG. 3(d) shows the results of mass spectrometry of mixed SAM(d).

As can be seen from the results of FIG. 3(a) to FIG. 3(d), each self-assembled monolayer is laser desorbed/ionized effectively into its specific disulfide type ion complex showing the molecular composition thereof, regardless of the particular type of the SAM.

The above results of mass spectrometry are shown in the following Table 2, individually for each type of SAM.

TABLE 2

| Sample | Detected Laser-Desorbed Ion | Mass (amu) |
|---|---|---|
| SAM(a) | (HO-(EG)₆-(CH₂)₁₁—S—S—(CH₂)₁₁-(EG)₆-OH)Na⁺ | 957.6 |
| SAM(b) | (H₃CO-(EG)₃-(CH₂)₁₁—S—S—(CH₂)₁₁-(EG)₃-OCH₃)Na⁺ | 721.5 |
| mixed | (H₂C═CH-(EG)₃-(CH₂)₁₁—S—S—(CH₂)₁₁-(EG)₃-CH═CH₂)Na⁺ | 773.5 |
| SAM(c) | | |
| mixed | (HC≡C-(EG)₃-(CH₂)₁₁—S—S—(CH₂)₁₁-(EG)₃-C≡CH)Na⁺ | 769.5 |
| SAM(c) | | |
| mixed | (H₂C═CH-(EG)₃-(CH₂)₁₁—S—S—(CH₂)₁₁-(EG)₃-CH≡CH)Na⁺ | 771.5 |
| SAM(c) | | |
| mixed | (HO-(EG)₃-(CH₂)₁₁—S—S—(CH₂)₁₁-(EG)₃-OH)Na⁺ | 693.4 |
| SAM(d) | | |
| mixed | (H₂N-(EG)₅-(CH₂)₁₁—S—S—(CH₂)₁₁-(EG)₅-NH₂)Na⁺ | 955.6 |
| SAM(d) | | |
| mixed | (HO-(EG)₃-(CH₂)₁₁—S—S—(CH₂)₁₁-(EG)₅-NH₂)Na⁺ | 824.5 |
| SAM(d) | | |

### Example 4

### Mass Spectrometry of SAM at Different Locations Via Pretreatment with Cationic Solution

NaI (Sigma-Aldrich, >99.99%) was dissolved into double distilled water to obtain a 10 mM aqueous Na⁺ cationic solution. The Na⁺ cationic solution thus prepared had a neutral pH. A self-assembled monolayer (SAM) of Au—S—(CH₂)₁₁-(EG)₆—OH (analytic area: 1×1 cm²), bound to Au (plate), having an alcohol group, a sulfur reactive group, an alkane chain group and an ethylene glycol moiety, was used as the test sample to be analyzed. The test sample was dipped into the aqueous Na⁺ cationic solution for 10 minutes, separated and recovered, and then dried in air at room temperature for 10 minutes.

Then, mass spectrometry was carried out by using the same conditions and system as described in Example 1. Laser beams were irradiated to sixteen (16) different locations in the SAM area (analytic area: 1×1 cm²) to determine a change in detection sensitivities at different locations.

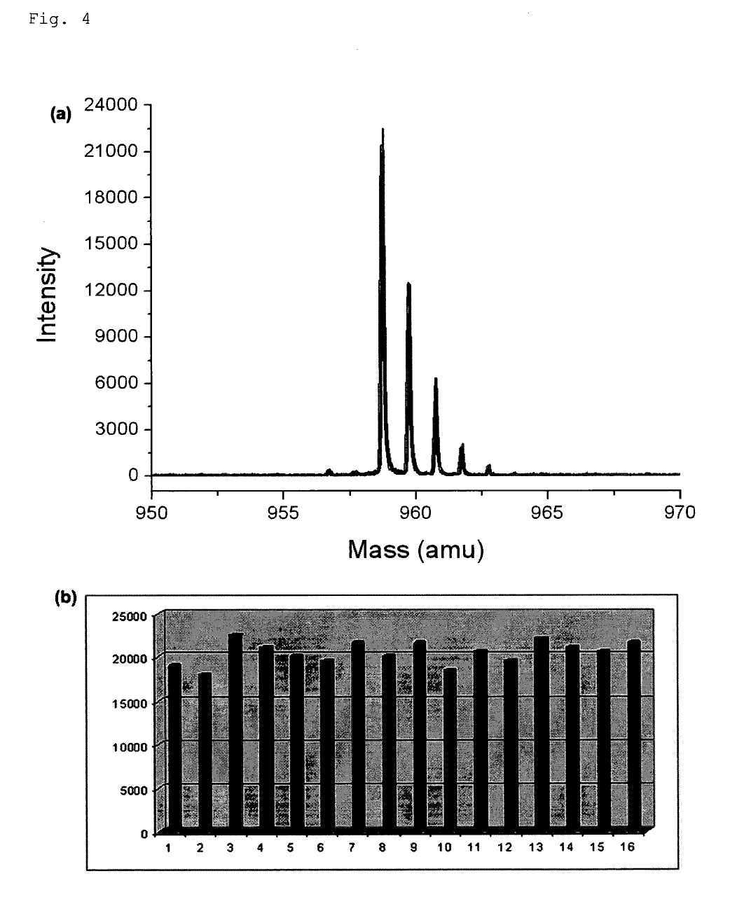

FIG. 4(a) illustrates the overall results of mass spectrum of (HO-(EG)₆—(CH₂)₁₁S—S—(CH₂)₁₁-(EG)₆—OH)Na⁺ determined at the sixteen different locations, and FIG. 4(b) illustrates the individual detection intensities at each location, based on the monoisotopic peak corresponding to a mass of 957.6 amu among the peaks shown in FIG. 4(a).

After examining the effects of the laser beam irradiation location upon the intensity, an average detection ion intensity was 20406.3 with a very small standard deviation of 1280.9 corresponding to 6.3%. The standard deviation is such a small value which may not be obtained in the case of mass spectrometry of a self-assembled monolayer using a matrix. This demonstrates that the method disclosed herein provides significant detection results that show the applicability of the method to quantitative analysis and enables two-dimensional chemical mapping.

### Example 5

### Mass Spectrometry of SAM Using Cationic Solutions with Different Concentrations

NaI (Sigma-Aldrich, >99.99%) was dissolved into double distilled water to obtain aqueous Na⁺ cationic solutions, each having a concentration of 5 mM, 10 mM, 25 mM, 50 mM, 75 mM, 100 mM, 150 mM and 200 mM. All the Na⁺ cationic solutions thus prepared had a neutral pH.

A self-assembled monolayer (SAM) of Au—S—(CH₂)₁₁-(EG)₆—OH bound to Au (plate) was used as the test sample to be analyzed. The test sample was dipped into each aqueous Na⁺ cationic solution for 10 minutes, separated and recovered, and then dried in air at room temperature for 10 minutes. Then, mass spectrometry was carried out by using the same conditions and system as described in Example 1.

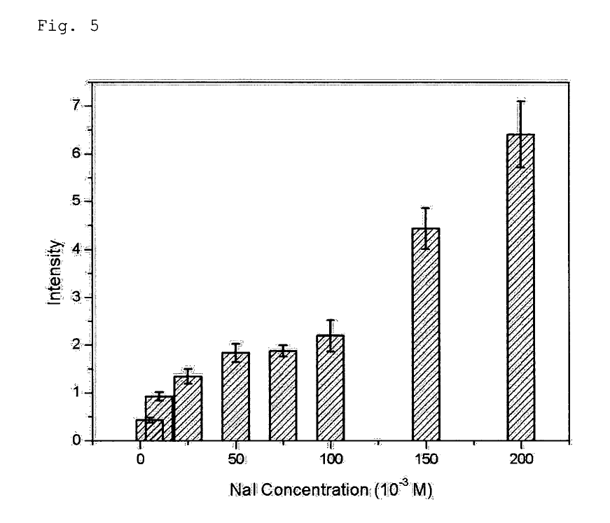

FIG. 5 is a graph showing the detection intensity as a function of the concentration of cationic solution, and demonstrates that the detection intensity increases in proportion to the molar concentration of cations. In FIG. 5, the detection intensity value at each molar concentration of cations is the average of intensity values measured at five optional locations, and is shown together with the standard deviation at each concentration. As can be seen from the results of FIG. 5, higher ion intensity is obtained as the concentration of cationic solution increases. Therefore, treatment with a cationic solution having higher concentration provides higher ion intensity. This demonstrates that the method disclosed herein provides high sensitivity.

### Example 6

### Mass Spectrometry of SAM Attached to Au Nanoparticles

As for the monolayer-protected gold nanoparticles (NPs), the ligand exchange method using citrate-stabilized gold NPs was employed. Typically, 250 mL of 0.01% HAuCl₄ (99.9+ %, Aldrich, P/N C520918) solution was heated to the boiling point with vigorous stirring. A volume of 8.75 mL of 34 mM sodium citrate tribasic dehydrate (Sigma, P/N C8532) solution was added to the vortex of the pale yellow solution, causing a color change to burgundy. The solution was boiled for 10 minutes and allowed to cool, while stirring was further continued for 15 minutes. The maximum absorbance of the resultant nanoparticle solution was observed at 518 nm. The average size of 127 sampled gold NPs was determined to be 15.9±0.9 nm by using transmission electron microscopy (TEM).

With the use of the citrate-stabilized gold NPs, the ligand exchanges of surface citrates with respective thiol reagents of HS—(CH₂)₁₁-(EG)₃—OH and HS—(CH₂)₁₁-(EG)₃—OCH₂—COOH were done.

For the synthesis of Au(NP)—S—(CH₂)₁₁-(EG)₃—OH, 190 μL of 1 M HS—(CH₂)₁₁-(EG)₃OH solution was added to a 40 mL solution of citrate-stabilized gold NPs with an optical density (OD) of 0.9 at 518 nm. The mixture was stirred for 12 h at room temperature. A 1 mL portion of the mixture was taken and centrifuged at 10000 rpm for 10 min. After the supernatant was removed, 1 mL of ethanol was added to rinse out unbound ligands. Then, gold NPs were re-suspended by vortexing and centrifuged again. After another washing step using ethanol, 1 mL of deionized water was added and the solution was vortexed to a suspension.

The suspension was stored in a 3.5 kDa cutoff membrane cassette and dialyzed in 1 L of deionized water to further remove unreacted reagents such as citrates and thiols.

For the preparation of Au(NP)—S—(CH₂)₁₁-(EG)₃—OCH₂—COOH, 190 μL of 1 M HS—(CH₂)₁₁-(EG)₃—OCH₂—COOH solution was added to a 40 mL solution of citrate-stabilized gold NPs with 0.9 OD at 518 nm with stirring. The mixture was stirred for 12 h at room temperature. Then, a small portion of solution mixture (500 μL) was taken and dialyzed in 500 mL of deionized water using a 3.5 kDa cutoff membrane cassette to remove residues in the nanoparticle solution.

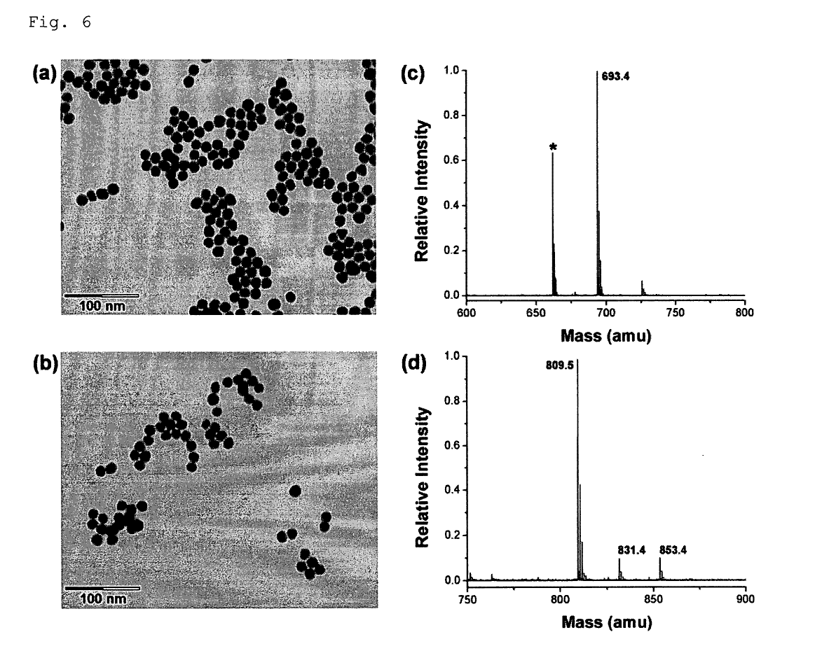

The TEM images in FIG. 6(a) and FIG. 6(b) show the gold NPs with about 16 nm diameter, which were protected with OH-terminated and COOH-terminated alkanethiolate monolayers by adsorption of thiol reagents of HS—(CH₂)₁₁-(EG)₃—OH and HS—(CH₂)₁₁-(EG)₃-OCH₂—COOH, respectively.

A self-assembled monolayer of Au(NP)—S—(CH₂)₁₁-(EG)₃-OH or Au(NP)—S—(CH₂)₁₁(EG)₃-OCH₂—COOH, attached to gold NPs, was used as the specimen to be analyzed. A volume of 0.5 μL of solution of the monolayer-protected gold NPs was dropped on a standard MALDI steel target (Bruker MTB plate).

An additional 0.5 μL drop of 1 mM NaI(aq) was applied and dried as in the dried-droplet method for MALDI sample preparations. Then, the mass spectra were taken by a MALDI-TOF mass spectrometer.

As shown in the laser desorption/ionization (LDI) mass spectrum (FIG. 6(c)), the cation-assistance gave the characteristic disulfide ions, (HO-(EG)₃-(CH₂)₁₁—S—S—(CH₂)₁₁(EG)₃-OH)Na⁺ at mass 693.4, from the surface of the gold NPs. More interestingly, even without the addition of NaI(aq) solution, the monolayer-protected gold NPs sample gave the same spectrum with a weaker intensity, which was probably caused by residual Na⁺ ions from the earlier synthetic steps.

The COOH-terminated gold NPs (FIG. 6(b) and FIG. 6(d)) gave three characteristic disulfide ions as well, which is in a good agreement with the previous MALDI experiment of the SAMs on the gold substrate. The three disulfide ions include (HOOC—CH₂O-(EG)₃—(CH₂)₁₁—S—S—(CH₂)₁₁-(EG)₃—OCH₂—COOH)Na⁺ at mass 809.5, (NaOOC—CH₂O-(EG)₃—(CH₂)₁₁—S—S—(CH₂)₁₁-(EG)₃—OCH₂—COOH)Na⁺ at mass 831.4, and (NaOOC—CH₂O(EG)₃-(CH₂)₁₁—S—S—(CH₂)₁₁-(EG)₃-OCH₂—COONa)Na⁺ at mass 853.4. This demonstrates that the method disclosed herein may also be applied to surface mass spectrometry of the monolayer-protected gold NPs.

The present application contains subject matter related to Korean Patent Application No. 10-2008-0038746, filed in the Korean Intellectual Property Office on Apr. 25, 2008, the entire contents of which is incorporated herein by reference.

While the present invention has been described with respect to specific embodiments, it will be apparent to those skilled in the art that various changes and modifications may be made without departing from the spirit and scope of the invention as defined in the following claims.

1. A method for carrying out matrix-free mass spectrometry, which comprises adding a cationic solution containing cations to an analyte sample including a self-assembled monolayer (SAM) on a surface of a substrate, and carrying out mass spectrometry of the self-assembled monolayer by using laser desorption/ionization.

2. The method for carrying out matrix-free mass spectrometry according to claim 1, wherein the cationic solution is an aqueous cationic solution.

3. The method for carrying out matrix-free mass spectrometry according to claim 1, wherein the cationic solution comprises an alkali metal cation, alkaline earth metal cation, organic cation, or a mixed cation thereof.

4. The method for carrying out matrix-free mass spectrometry according to claim 1, wherein the cationic solution comprises cations in a molar concentration of 0.0001 mM to 1 M.

5. The method for carrying out matrix-free mass spectrometry according to claim 2, wherein the cationic solution is a solution in which an alkali metal salt, alkaline earth metal salt, organic salt or a mixed salt thereof is dissolved.

6. The method for carrying out matrix-free mass spectrometry according to claim 5, wherein the alkali metal salt, alkaline earth metal salt or mixed salt thereof is a salt whose anion is selected from the group consisting of iodide, fluoride, chloride, bromide, hydroxide, phosphate, nitrate, acetate, citrate, tartarate, sulfate, carbonate or oxychloride ions.

7. The method for carrying out matrix-free mass spectrometry according to claim 1, wherein the cationic solution is added to the analyte sample by dipping the analyte sample into the cationic solution, by spraying the cationic solution onto the analyte sample, or by dropping liquid droplets of the cationic solution on the analyte sample.

8. The method for carrying out matrix-free mass spectrometry according to claim 1, wherein the self-assembled monolayer comprises an oxygen-containing moiety.

9. The method for carrying out matrix-free mass spectrometry according to claim 8, wherein the oxygen-containing moiety is at least one moiety selected from the group consisting of ethylene glycol (—O—CH₂—CH₂—), carboxylic acid (—COOH), alcohol (—OH), ether (—O—), ester (—COO—), ketone (—CO—), aldehyde (—COH), amide (—NH—CO—) and aromatic derivatives thereof.

10. The method for carrying out matrix-free mass spectrometry according to claim 1, wherein the self-assembled monolayer comprises a functional group that reacts or binds specifically with a chemical or biochemical substance, and a sulfur reactive group.

11. The method for carrying out matrix-free mass spectrometry according to claim 1, wherein the self-assembled monolayer comprises a functional group to which an organic polymer, organometal compound, peptide, carbohydrate, protein, lipid, metabolite, antigen, antibody, enzyme, amino acid, aptamer, saccharide or nucleic acid is fixed.

12. The method for carrying out matrix-free mass spectrometry according to claim 1, wherein the mass spectrometry is carried out by using a time-of-flight mass spectrometer (TOF-MS), matrix-assisted laser desorption/ionization Fourier transformation-mass spectrometer (MALDI FT-MS), matrix-assisted laser desorption/ionization quadrupole-time-of-flight (MALDI q-TOF), or atmospheric pressure matrix-assisted laser desorption/ionization (AP-MALDI) system.
